(19) United States
(12) Patent Application Publication
(10) Pub. No.: US 2007/0140652 A1
(43) Pub. Date: Jun. 21, 2007

(54) Display apparatus for having a scheduling function to play recorded programs and a method thereof

(75) Inventor: Chae Su Park, (US)

Correspondence Address: KED & ASSOCIATES, LLP, P.O. Box 221200, Chantilly, VA, 20153-1200, US

(73) Assignee: LG Electronics Inc.

(21) Appl. No.: 11/641,803

(22) Filed: Dec. 20, 2006

(30) Foreign Application Priority Data
Dec. 20, 2005 (KR) 10-2005-0126133

(51) Int. Cl. H04N 5/91

(52) U.S. Cl. 386/83

(57) ABSTRACT

A display device for having a scheduling function to play a recorded program and the method thereof is disclosed. The present invention includes a display device for having a scheduling function to play a recorded program comprising a memory for storing the recorded program, a user interface for setting a scheduled time to play the recorded program, a time counter for comparing the scheduled time with a clock inside the display device, and a controller for playing the recorded program if the scheduled time matches with the clock inside the display device. Also, a method for scheduling to play a recorded program comprises storing the recorded program, setting a scheduled time to play the recorded program, comparing the scheduled time with a clock inside the display device, and playing the recorded program if the scheduled time matches with the clock inside the display device.

This application claims the benefit of Korean Patent Application No. 10-2005-0126133, filed on Dec. 20, 2005, which is hereby incorporated by reference.

### BACKGROUND OF THE INVENTION

1. Field of the Invention

The present invention relates to a display device, and more particularly, to a display device for having a scheduling function to play recorded programs and method thereof.

2. Discussion of the Related Art

Heretofore, broadcast programs were recorded on a storage area for future viewing. However, increased recorded programs make it difficult to find and play a desired program at the time when the user wanted.

FIG. 1 is a conventional flowchart for managing recorded broadcast programs. While watching a real time broadcast program (S101), the user decides if she records the program (S102). If she decides to record, she presses the record button using a user interface including a remote control, a keyboard, a mouse, a mechanical button, and a graphic user interface (GUI) (S103).

Alternately, while watching a real time broadcast program, she pushes a button for displaying an Electronic Program Guide (EPG) (S104) and select any one of the programs on the EPG list to schedule recording (S105). If she wants to record now (S106), then the broadcast program is recorded and saved (S107). Later time, only if the user wants to play one of the recorded programs (S108), the recorded program is played (S109). But, unless the user remembers the recording and intentionally find and play the recorded program, it is probable that the recorded program is buried in lots of recorded programs and/or deleted unintentionally without viewing.

Therefore, it is highly desired to develop a display device for having a scheduling function to play the recorded program when recording the broadcast program.

### SUMMARY OF THE INVENTION

Accordingly, the present invention is directed to a display device for having a scheduling function to play a recorded program and the method thereof that substantially obviates one or more problems due to the limitations and disadvantages of the related art.

An object of the present invention is to provide more convenient user interface to the user by scheduling later time to watch recorded program while recording.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display device for having a scheduling function to play a recorded program comprising a memory for storing the recorded program, a user interface for setting a scheduled time to play the recorded program, a time counter for comparing the scheduled time with a clock inside the display device, and a controller for playing the recorded program if the scheduled time matches with the clock inside the display device.

In another aspect of the present invention, a method for scheduling to play a recorded program comprising storing the recorded program, setting a scheduled time to play the recorded program, comparing the scheduled time with a clock inside the display device, and playing the recorded program if the scheduled time matches with the clock inside the display device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a flowchart for managing broadcast programs of the conventional invention;

FIG. 2 illustrates a block diagram of a display device of the present invention;

FIG. 3 illustrates an exemplary display screen for scheduling a replay setting of the present invention;

FIG. 4 illustrates an exemplary display screen for confirming if the user really wants to play the scheduled program;

FIG. 5 illustrates a flowchart for managing broadcast programs of the present invention; and

FIG. 6 illustrates another flowchart for managing broadcast programs of the present invention.

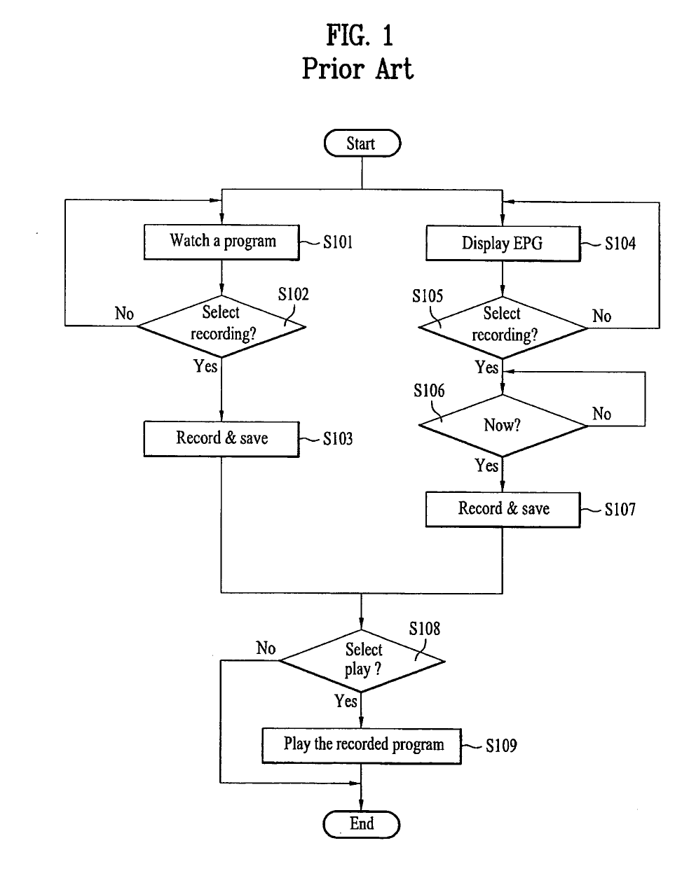

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

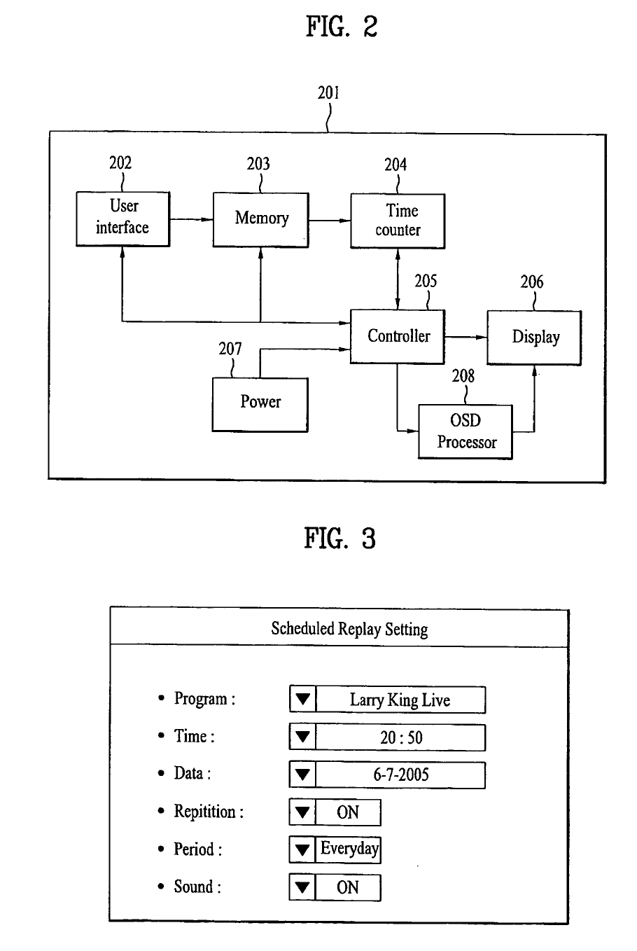

FIG. 2 shows an exemplary display device (201) having a scheduling function to play recorded programs. The conventional elements are omitted in this diagram. The display device (201) may include a digital television, a personal video recorder (PVR), a digital video recorder (DVR), and various formats of recording elements such as Hard Disk Drive (HDD), MD, Digital Video Drive (DVD)+R/−R, DVD+RW/−RW, a memory card, and Digital-Video Home System (D-VHS).

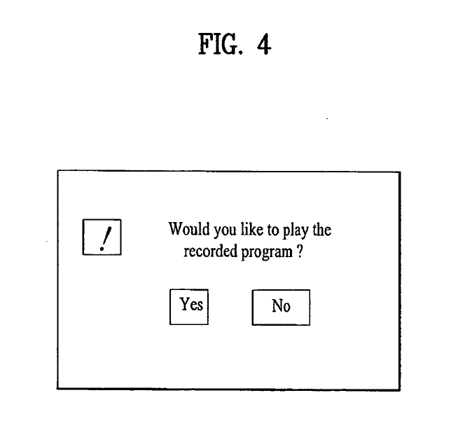

In the display device (201), a user inputs commands through the user interface (202) which includes a remote control, a keyboard, a mouse, a mechanical button, local keys attached in the device and a graphic user interface (GUI). While recording a real time broadcasting program, the user can set up when the recorded program will be played as shown in FIG. 3. The user schedules time, date, repetition, repetition period, and sound of the program. The memory (203) stores recorded programs. The time counter (204) compares the scheduled time with the clock inside the display device (201). When the scheduled time matches the clock inside the display device (201), the OSD processor (208) generates such a question as shown in FIG. 4, and display at the display (206) asking for confirmation from the user to play the scheduled program, instead of just playing the scheduled program. The OSD screen includes Picture in Picture (PIP), Picture out Picture (POP) and a full screen. The controller (205) is operated by getting the power from power unit (207) and controls all elements in the display device (201). The display (109) displays signals from the memory (203). Also, the On Screen Display (OSD) processor (208) outputs a menu, a list or a guide for the user.

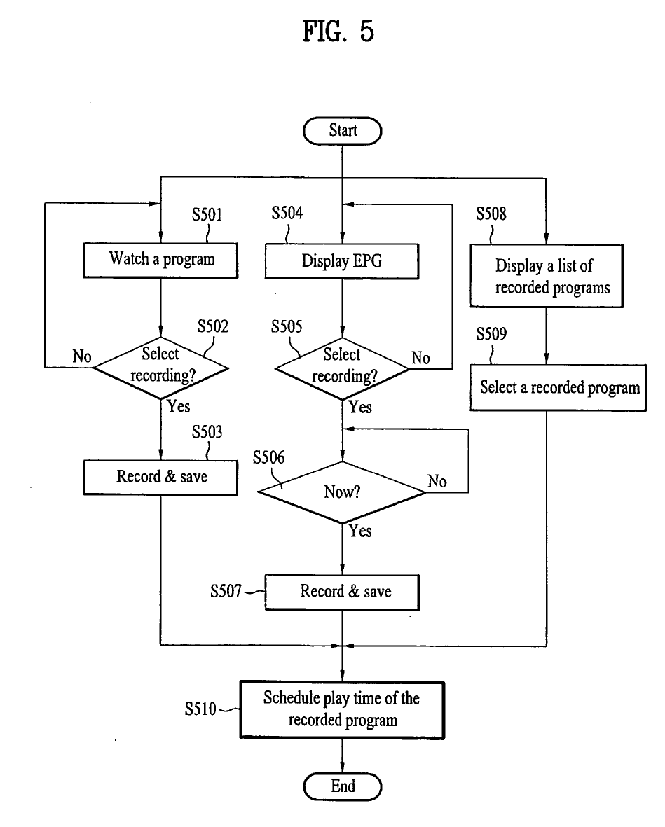

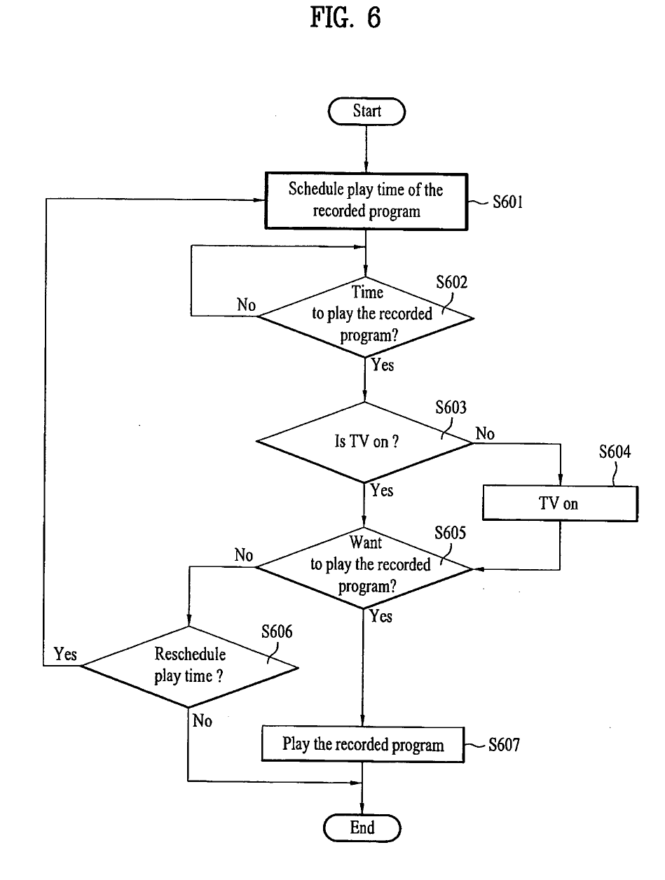

Now, operations for scheduling broadcast programs of the present invention are explained. FIG. 5 shows that the recorded program is scheduled after saved at the memory (S510). Also, a list of recorded program is displayed using OSD screen (S508). By selecting one from the list, the user can schedule and/or reschedule to view the recorded program. FIG. 6 is a continuation from FIG. 5. S510 and S601 are the same step. When the play time comes, i.e., i the controller (205) asks if the display (206) is on (S603). If the display (206) is off state, the controller (205) turns the display (206) on. After the display is on, the OSD screen asks if the scheduled program is played as shown in FIG. 4 (S605). If the user does not want watch at that time, the controller (205) asks if the user will reschedule to play the recorded program (S606). If the user agrees to watch, the scheduled program is played (S607).

While the invention has been described with respect to the physical embodiments constructed in accordance therewith, it will be apparent to those skilled in the art that various modifications, variations and improvements of the present invention can be made without departing from the spirit or scope of the inventions. Thus, it is intended that the present invention covers the modifications and variations of this invention provided they come within the scope of the appended claims and their equivalents.

What is claimed is:

1. A display device for having a scheduling function to play a recorded program comprising:
a memory for storing the recorded program;
a user interface for setting a scheduled time to play the recorded program;
a time counter for comparing the scheduled time with a clock inside the display device; and
a controller for playing the recorded program if the scheduled time matches with the clock inside the display device.

2. The display device of claim 1, further comprising a display for displaying the recorded program.

3. The display device of claim 1, wherein the recorded program is played at the same time in everyday or once a week.

4. The display device of claim 1, further comprising an On Screen Display (OSD) processor for asking if the user wants to play the recorded program.

5. The display device of claim 4, wherein the user interface is one of a remote control, a keyboard, a mouse, a mechanical button, and a graphic user interface (GUI).

6. A method for scheduling to play a recorded program comprising:
storing the recorded program;
setting a scheduled time to play the recorded program;
comparing the scheduled time with a clock inside the display device; and
playing the recorded program if the scheduled time matches with the clock inside the display device.

7. The method of claim 6, further comprising displaying the recorded program.

8. The method of claim 7, wherein the recorded program is played at the same time in everyday or once a week.

9. The method of claim 7, further comprising asking if the user wants to play the recorded program.

10. The method of claim 9, wherein the user interface is one of a remote control, a keyboard, a mouse, a mechanical button, and a graphic user interface (GUI).
